(19) United States
(12) Patent Application Publication
(10) Pub. No.: US 2002/0072954 A1
(43) Pub. Date: Jun. 13, 2002

(54) Performance tracker TM system

(76) Inventor: Tim Sales, Woodland Hills, CA (US)

Correspondence Address: Mavis S. Gallenson, Esq., c/o LADAS & PARRY, Suite 2100, 5670 Wilshire Boulevard, Los Angeles, CA, 90036-5679, US

(21) Appl. No.: 09/735,883

(22) Filed: Dec. 12, 2000

(51) Int. Cl. G06F 17/60

(52) U.S. Cl. 705/10; 705/5; 705/8

(57) ABSTRACT

A computer system which allows a company to keep a detailed record of its sales and marketing activities, and in particular keep track of sales and marketing activities performed by sales representatives employed by the company. The computer system comprises a server connected to the Web, a plurality of client computers also connected to the Web and having access to the server via the internet, software to render sales and marketing support services, and a database to store information. Part of the software, a TRACKER™ tool allows a sales representative to keep track of his sales and marketing activities, a LEADS HARVESTER™ tool automatically generates sales leads in the form of email addresses of likely customers, and a FOLLOW-UP SEQUENCE™ tool allows the user to design and implement automated email-based marketing campaigns. A method of tracking sales and marketing activities of a sales representative, automatically generating a plurality of sales leads pertaining to a warm market, and implementing an automated email-based marketing campaign. A Web site to assist at least one user with sales and marketing activities.

### TECHNICAL FIELD

The present disclosure relates to a device, a system and a method which support a company's or an individual's sales and marketing activities. In a sample, non-limiting embodiment the system, method, and apparatus of this disclosure track the activities and performance of an employee or individual, provide guidance to the employee or individual in implementing automated internet-based marketing campaigns and help determine/identify the specific area or areas an employee or individual needs training in, as well as which sales and marketing strategies are most effective.

### BACKGROUND

The Internet is a well-known collection of networks that work together (cooperate) using common protocols to form a world wide network. It allows users to access, from their personal computers, a collection of web sites commonly referred to as the World Wide Web or “Web” for short. With the increasing popularity of the Web, it has become common for merchants to set up web sites for marketing and selling goods, and a growing number of these web sites offer interactive personalized services.

### SUMMARY

In the following, the term “activities” mainly refers to those actions which create success in sales. However, this definition is not meant to limit the meaning of the term “activities”, and in some instances this term may have a broader meaning than that suggested above.

In accordance with the present disclosure a computer system is disclosed, which allows a company to keep a detailed record of its sales and marketing activities, and in particular to keep track of sales and marketing activities performed by sales representatives employed by the company or independent contractors (such as in Real Estate or Network Marketing). In the case of Network marketing, it would be an individual or and independent contractor.

In one embodiment the computer system comprises a server connected to the Web, and a plurality of client computers also connected to the Web which have access to the server via the Internet. The server is preferably located on the premises of a provider company which is responsible for maintaining the server, while the client computers are located on the premises of one or several client companies. Also comprised in the computer system is software which renders sales and marketing support services to sales representatives operating the client computers, and a database to store information.

The software comprises a PERFORMANCE TRACKER™ system tool which includes a tracking module (TRACKER™ tool), a LEADS HARVESTER™ tool, and a FOLLOW-UP SEQUENCE™ tool.

The TRACKER™ tool allows a sales representative or user to keep track of his or her sales and marketing activities, the LEADS HARVESTER™ tool automatically generates sales leads in the form of email addresses and full contact information of likely customers because they were informed by a friend, family member or associate, while the FOLLOW-UP SEQUENCE™ tool allows the user to design and implement automated email-based marketing campaigns.

In an other aspect of this disclosure, a method of tracking activities of an employee, individual or sales representative is provided, the method comprising the steps of providing a Web site with Web pages, reading from the Web pages information entered by the user, transmitting this information to the server via the internet, and storing the information in a database to be used by the user as well as a manager, upline (as in Network Marketing), a coach etc., to identify weaknesses and suggest ways to improve.

In yet another aspect, this disclosure provides a method of automatically generating a plurality of sales leads pertaining to a warm market. The method includes the step of sending marketing email messages to a plurality of people, educating the email recipients about a subject, product or service, providing the option to the recipients to forward the email message to other people (such as friends, family and acquaintances), keeping track of the email addresses of the people to which these email messages are forwarded to, thereby building a sales leads cluster formed of a plurality email addresses of likely customers.

In another aspect of this disclosure a method of implementing an automated email-based marketing campaign is provided, the method comprising the steps of designing at least one email message to promote a product or service, attaching a multi-media presentation and sending email messages to a plurality of potential customers, following-up these email messages with other email messages that may or may not contain presentations or otherwise contacting the email messages recipients, tailoring new email messages according to the manner in which recipients responded or did not respond to a previous email message, and sending said new email messages to the recipients. This method may further include the steps of providing an intuitive expert system, interpreting the content of email messages sent by the recipients, and generating a preferably preselected, appropriate email response thereto.

One embodiment allows a user to determine if the promotions he implemented are creating prospects, by locating names/leads. If no prospects are created, then the user may perfect/adjust his promotion activities or do more of them. The TRACKER™ tool will also recommend courses to take to learn how to better promote. It determines if user's “dials” are creating conversations, if conversations are creating appointments, if appointments are creating opportunities for presentations. It also helps the user answer the following questions: are the user's presentations creating product sales? Are sales creating re-sales? Are re-sales creating referrals?

In yet another aspect of this invention, a Web site is provided which provides sales and marketing support to at least one client company (for example allowing each company to select items they will sell). The Web site comprises a TRACKER™ Web page to access the TRACKER™ tool, a LEAD GENERATOR™ Web page to access the LEADS HARVESTER™ tool, and a FOLLOW-UP™ Web page to access the FOLLOW-UP™ tool.

In another aspect, this invention provides a tool and method for real-time statistical analysis of activities performed by sales people. This real-time statistical analysis is based not only on the number of sales, but also on the activities that made up or triggered each sale. This information helps a company precisely identify the areas in which training efforts should be placed for each individual sales representative.

This concept may be useful in other fields than the field of sales. Broadly, in one aspect this invention relates to a tool and method for real-time statistical analysis of activities performed by people towards the accomplishment of a goal. This real-time analysis is based not only on the number of accomplishments, but also on the activities that make up or lead to each accomplishment. This information helps a company/individual precisely identify and define the areas in which training efforts should be placed for each individual.

### BRIEF DESCRIPTION OF THE DRAWINGS

The attached drawings are presented for purposes of illustration and not limitation. They are presented to clarify the concepts discussed in this description.

FIG. 1 is a block diagram illustrating an embodiment of the computer system in accordance with the invention;

FIG. 2 is a block diagram illustrating an embodiment of the components of the software in accordance with the invention, and the interaction of these components;

FIG. 3 is an exemplary Web page illustrating the process of logging in to the Web site in accordance with the invention; and

FIG. 4 is an exemplary homepage of the Web site in accordance with the invention, wherein certain features of the PERFORMANCE TRACKER™ system are shown.

### DETAILED DESCRIPTION

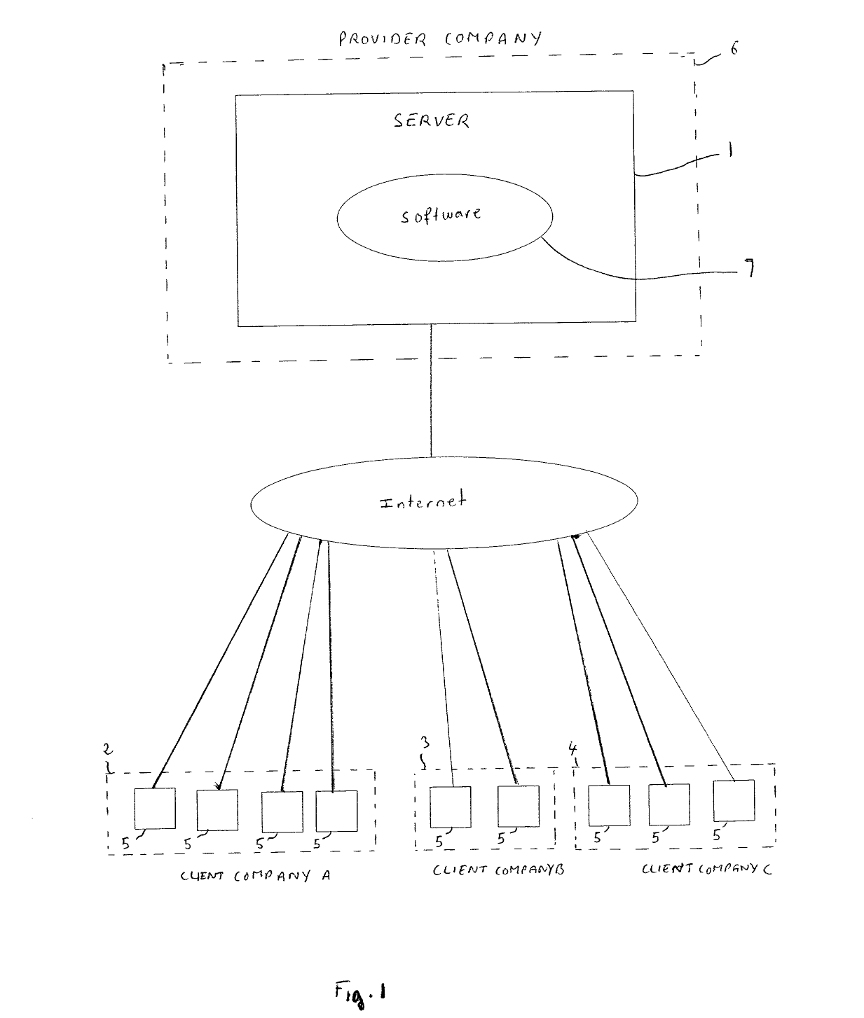

Turning to FIG. 1, in one aspect this invention provides a system which comprises a centralized computer system or server 1 connected to the world wide web via the internet, and a plurality of client computer systems 5 also connected to the world wide web via the internet. Each client computer system 5 may access the server 1 via the internet view its own activities as well as the activities of individuals, employees or sales associates.

In an exemplary application of this system, a provider company 6 provides services to a plurality of client companies 2, 3, and 4. The provider company 6 sets up and maintains the server 1. The server 1 comprises PERFORMANCE TRACKER™ system software 7 which controls the nature of the services provided by the provider company and carries out the rendering of these services to the client companies 2, 3, and 4. Each of the client companies 2, 3, and 4 may access the server to obtain services via the client computer systems 5. The client computer systems 5, may comprise internet-capable personal computers, internet-capable wireless devices such as portable computers and cellular telephones, or any other electronic devices which give access to the world wide web.

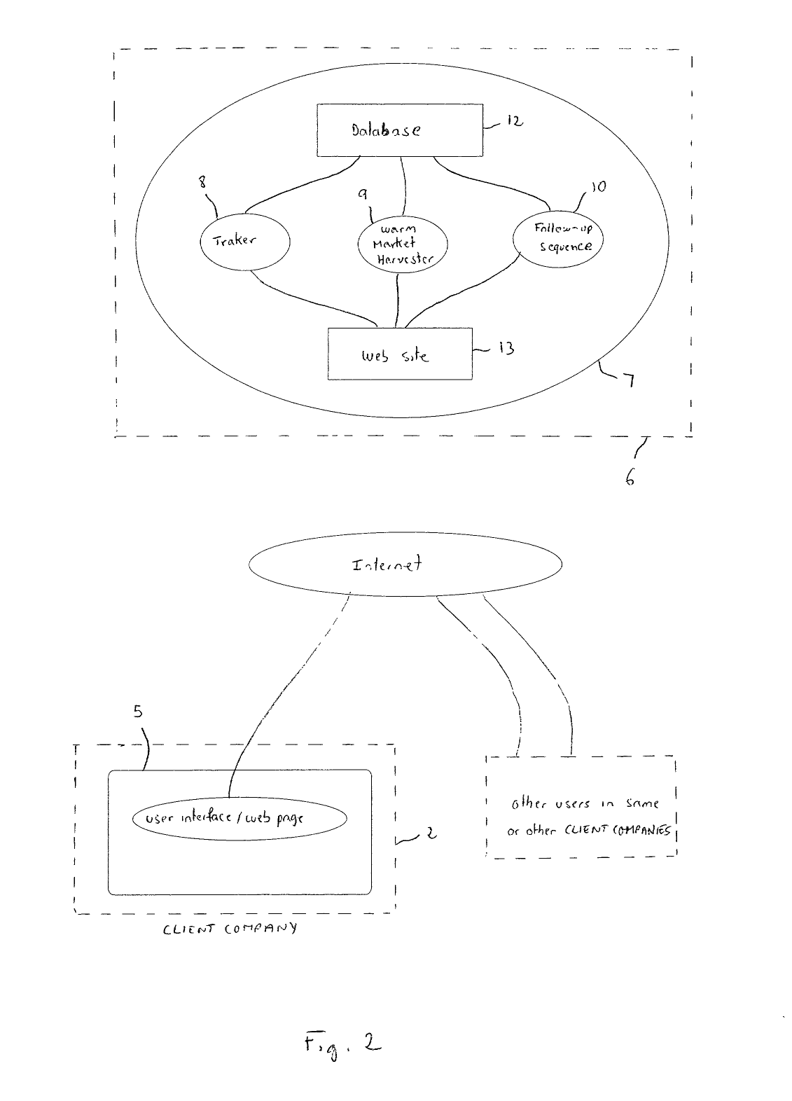

In a preferred embodiment of the present invention shown in FIG. 2, the provider company provides sales and marketing support to the client companies including identifying activity targets, generating sales leads, enhancing sales tools, tracking performance of sales and sales personnel, designing and implementing automated marketing campaigns.

The PERFORMANCE TRACKER™ system 7 comprises a tracking module or tracker 8 which keeps a detailed record, in a database, of sales and marketing activities of each client company, and in particular of activities of the sales personnel. The software 7 may also comprise a LEADS HARVESTER™ for implementing a method of generating sales leads to define warm markets. The software 7 may further comprise a FOLLOW-UP SEQUENCE™ tool, which lets a sales person design and launch an electronic mail (email) based marketing campaign, and allows the user to define an automated FOLLOW-UP SEQUENCE™ of actions as part of the marketing campaign based upon the recipient's response or lack thereof.

The provider company may offer the services provided by the PERFORMANCE TRACKER™ system in the form of a subscription with a one-time initiation fee followed by monthly payments for example. The PERFORMANCE TRACKER™ system may also be licensed to other provider companies which can then offer the PERFORMANCE TRACKER™ system services to client companies.

The PERFORMANCE TRACKER™ system is not industry specific or product specific, but rather is a versatile tool which may be used in any industry to track activities that create success in an industry or subject or to sell and market any kind of product, good and service.

Upon subscribing to the PERFORMANCE TRACKER™ system services, a client company is given master account information including a password which allows access to the master account via the internet. A company employee responsible for managing this master account, a manger for example, may then easily initialize the PERFORMANCE TRACKER™ system and customize its features to the particular industry of interest and the particular products, goods and services the client company is offering. For example, in the automotive industry, activities that would be tracked might be calls out to prospective buyers, number of walk-ins onto car lot from a promotional ad, referrals from previous customers obtained and called, number of cars sold for the day, week, month, year, etc. In the network Marketing industry for example, the activities would be number of dials, number of connects to people, number of appointments set to show the business plan, number of presentations given, number of new representatives signed in to company, etc.

A plurality of sub-accounts may be created by the manager for use by the sales personnel. In one embodiment, the manager may create up to five accounts. However, in accordance with this invention a system and method may be designed which allow the creation of any number of accounts. Each sales representative is given a personal sub-account which he or she can access with sub-account log-in and password information. The master account has access to the information stored under all sub-accounts as well as all other information pertaining to the client company which own this master account. However, each sub-account can only access its own sub-account information or information for which the master account has given access privileges. Different sub-accounts may be given access privileges to different information.

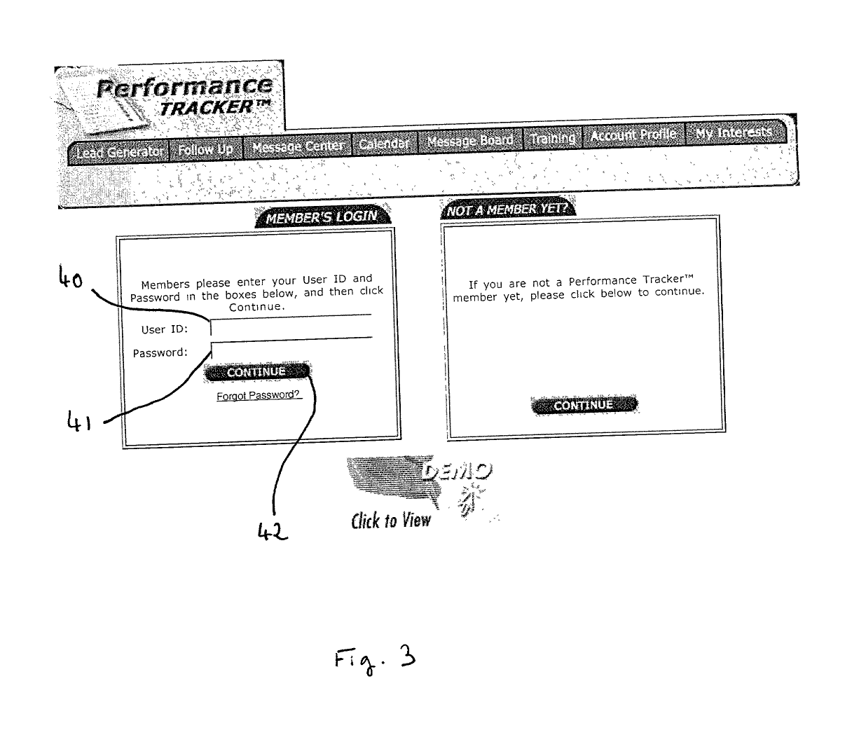

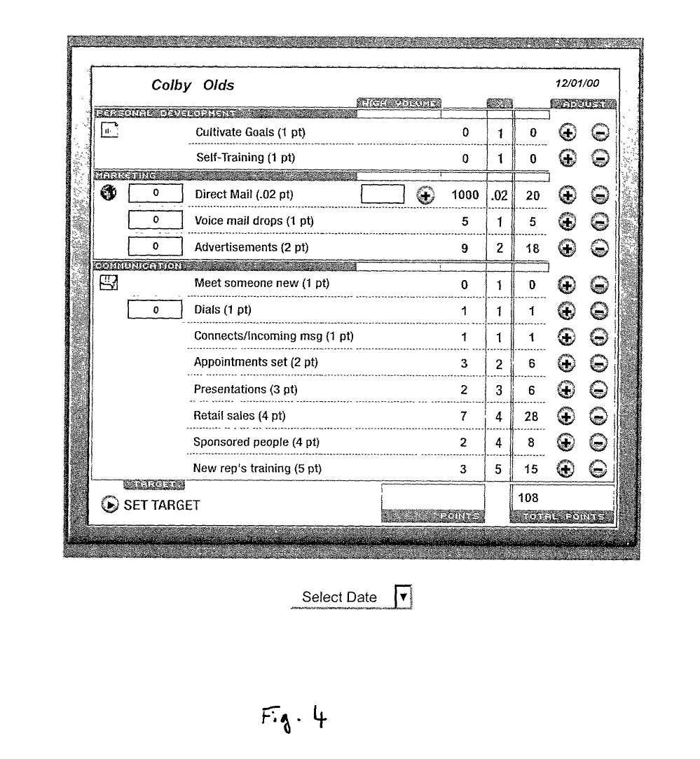

After the master account and sub-accounts have been set up, a sales representative or user may access his or her sub-account by first accessing the PERFORMANCE TRACKER™ system web site (an example of a web address may be www.performancetracker.com) via a web browser (Netscape®, Explorer® or other) The user is presented with a web page similar to the web page shown in FIG. 3 and may then access his account by entering his log-in information, typically consisting of a username 40 (or email address) and a password 41. By then clicking on “CONTINUE” hyperlink 42, the user is given access to his account and a PERFORMANCE TRACKER™ system homepage similar to the web page shown in FIG. 4, is uploaded into the user's web browser. Other ways know in the art of logging in to a web site are also adequate.

From the PERFORMANCE TRACKER™ system homepage, the user may access the tools and modules included in the PERFORMANCE TRACKER™ system and any information and data for which he has been given access privileges.

### TRACKER™ Tool

One of the modules included in the PERFORMANCE TRACKER™ system 7 is the TRACKER™ tool 8 shown in FIG. 2. The role of the TRACKER™ tool 8 is to keep track of all sales and marketing related activities performed by a client company 2. To facilitate understanding, the TRACKER™ tool is discussed in conjunction with a single client company and a single sales representative or user within this client company. It is however understood that the TRACKER™ tool may provide services to a plurality of client companies and users simultaneously.

For a given client company, a detailed record of all sales and marketing related activities (e.g., those activities which create success in sales) is kept in a database 12 which can be accessed by the TRACKER™ tool. The information pertaining to a given client company is stored in an area of the database 12 which is specifically allocated to the client company and is linked to the client company's master account. Although the database may contain information relating to different client companies, a given company has, preferably, only access to its own account and may not access information pertaining to other client companies.

After logging in to the PERFORMANCE TRACKER™ system, the user may interactively enter data related to his sales and marketing activities. One or several data entry windows comprising a list of data items and associated data entry boxes are provided to guide the user through the data entry process. In this manner, all sales representatives or users can enter data in a uniform fashion which facilitates data management and increases the significance of statistical information derived from the data collected by the users.

Preferably, all possible aspects of sales and marketing activities are covered by the data entry windows, including telephonic, mail and email activities, and in-person meetings. Every time a user places a telephone call, mails a letter, sends an email, or meets with a customer, the user preferably enters the information data associated with the specific activity he conducted. This information data preferably includes customer contact information (e.g., name, company, address, telephone numbers, email address, etc), the customer's response to the activity (e.g., purchase, not interested, contact later, sent more information, etc.), the date and time the activity was performed, and the next activity which is to be performed along with its scheduling.

After entering information data relating to an activity, the information is automatically transmitted to the data entered to the server over the internet, to then be stored in a proper area of the database. At any time the user may modify the information previously entered in order, for example, to correct errors.

The information thus stored in the database may be accessed by the user to help him assess which sales and marketing activities are most effective and generate most sales. For example, a sales cycle might be broken down to: promotion, create leads, dials, connects, set appointment, present product, follow up, make sale. These actions are preferably performed in that order, although the skilled person could easily imagine different order. Also useful may be the amount of time spent on marketing a product or service before a sale occurs. To support and facilitate this assessment, a statistical module is provided, which allows the user to create charts, tables, histograms, etc. In this manner, the user is able to visualize his activities and craft new and effective sales and marketing strategies, or simply use the ones which have proven to be most successful.

This information collected by a user may be shared with other users who can then benefit from the experience and activities of other users. Training of new inexperience users is thus greatly facilitated and may be based on sales and marketing strategies used by successful users.

The person with access to the master account, i.e., the master user, has access to every the user's account, and can thus monitor the activities of the sales personnel. For a given sales representative, promotions, bonuses, profit sharing, etc., may be implemented by the manager in charge, based on the activities of a sales representative. The performance evaluation of a sales representative may thus be based on accurate data instead of other subjective factors. Consequently, knowing that his activities are being monitored, a sales representative will have a higher incentive to produce more work, in particular if he wishes to be rewarded for his performance.

The different features provided by the TRACKER™ tool, such as the data entry windows, are accessed by clicking on the corresponding hyperlink which then uploads the corresponding web page, in a fashion well know in the art.

In an improved version of the TRACKER™ tool, part of the information is no longer entered by the user, but is instead, automatically recorded into the database. This is realized with a data collection utility which collects information, transfers it to the server over the internet, provides it to the TRACKER™ tool to then be written into the database. For example, during a telephonic activity, the data collection utility may automatically gather the customer's name, telephone number, date and time of call, and length of call from a Caller Id device. Further, during an email activity, the data collection utility may automatically gather the customer's email address and the time and date of the activity. This saves valuable data entry time to the user who can then better concentrate on other important aspects of his sales and marketing activities, and is also able to increase the number of activities he performs.

### LEADS HRVESTER™ tool

Another module included in the PERFORMANCE TRACKER™ system is the LEADS HARVESTER™ tool 9 as shown in FIG. 2. The LEADS HARVESTER™ tool implements an email-based method of automatically generating sales leads associated with a warm market. The sales leads are generated in the form of lists of email addresses and contact information of potential customers. We define a sales lead cluster as a group of email addresses, wherein the owner of a given email address in the group, knows an owner of at least one other email address in the group. In other words the people associated with the email addresses in the lead cluster are connected to some degree by some kind of relationship.

The LEADS HARVESTER™ tool is capable of generating sales lead clusters which may be used as a basis for subsequent email marketing campaigns.

In accordance with the LEADS HARVESTER™ tool method, email messages are sent to an initial group of people, the emails of whom have been previously obtained. These email messages may contain information about products or services, including multi-media presentations of these subjects, products or services. For example, when an email recipient opens the email message, a product or service presentation may be automatically launched. Alternatively, the recipient may be delivered a written email message and given the option to launch a multi-media presentation of the product or service sold by the company. The multi-media presentation may be included as an attachment to the email message or the email message may contain a link to a web site from which the presentation may be launched.

At the end of such presentation the recipient is presented with a window which gives him the opportunity to enter the email addresses of people he knows (e.g., family, friends, acquaintances, colleagues, etc.) who may be interested in the subjects, products or services presented. If he opts to enter such email addresses, a similar email message he received is automatically forwarded to the email addresses he entered, and an email message containing these email addresses is sent to the LEADS HARVESTER™ tool. If he decides not to enter any email addresses, but directly forwards the email message to one or several people, an embedded utility automatically sends an email message to the LEADS HARVESTER™ tool containing the email address of the people to whom the marketing email message was forwarded to.

Each recipient of the email messages may then forward the email message they received to one or several people they know who may be interested in the subject, product or service sold. These people may in turn forward the email message to other people and so on.

For each email message received by the LEADS HARVESTER™ tool, the email address from which the email message originated is recorded. In this manner, the LEADS HARVESTER™ tool is able link every email address collected to at least one other email address collected. A lead cluster comprising email addresses of people who are linked to some degree by a personal or professional relationship, is thus progressively built.

The content of the email messages sent by the sales representative using the LEADS HARVESTER™ tool to build a lead cluster may be customized. The sales representative can select the subject of the email message, create a written message in the body of the email, and choose the type of presentation included in the email.

### FOLLOW-UP SEQUENCE™ tool

Another module included in the PERFORMANCE TRACKER™ system is the FOLLOW-UP SEQUENCE™ tool 10 as shown in FIG. 2. The role of the FOLLOW-UP SEQUENCE™ tool is to assist the user in conducting automated email-based marketing campaigns. A marketing campaign is typically defined as a series of events having for purpose to promote a product or service.

In accordance with the FOLLOW-UP SEQUENCE™ tool the user first obtains a list of email addresses which he wishes to target. This list of email addresses may have been created by the LEADS HARVESTER™ tool, but may also have been otherwise purchased or obtained, or created in any suitable way known in the art.

The user then designs the email messages which will deliver the product or service information to the people targeted (targets) by the marketing campaign, and deliver follow-up messages according to the response or lack of response from these targets. A marketing campaign design utility guides the user through the design of the email messages, and provides suggestions as to the content and form of the email messages. For example, a multi-media presentation of the products or services offered may be included as an attachment to the email message. This presentation may be audio, video, may comprise one or several pictures, or may simply consist of a written message. Alternatively, the presentation may not be attached to the email message, and a link to a web site may be included in the email message. The target has then the option to click on this link, which will upload a web page presenting the products or services sold. From this web page, a multi-media presentation may be launched by the target, in the form of a streaming video or animation for example. Any kind of presentation known in the art, multi-media or other, is adequate. PERFORMANCE TRACKER™ allows the user to add a multimedia presentation, an email and/or a follow-up sequence via the Master. If accepted by the Master, it will dynamically be added to all the sub-accounts for use.

After the user has selected the content and form of these marketing email messages, the FOLLOW-UP SEQUENCE™ tool allows him to create a customized sequence of events which form part of the marketing campaign.

There are many ways in which a target (i.e., a recipient of a marketing email message) may respond or not respond to a marketing email message. A Response Type utility determines for each email message sent, the manner in which the target responds or does not respond to the email message, and reports this information to the FOLLOW-UP SEQUENCE™ tool. As part of the marketing campaign design, the FOLLOW-UP SEQUENCE™ tool allows the user to predetermine the series of actions to be taken in response to the way in which a target responds to a marketing email message. This series of action or FOLLOW-UP SEQUENCE™ may comprise resending the original email message or sending a different marketing email message. The number of times a marketing email message is to be sent is also predetermined by the user at the campaign design stage.

A target may respond as follows in response to a marketing email message:

He may delete the received email message without even opening the message, based on the content of the “subject” field of the email. In this case, the Response Type utility reports to the FOLLOW-UP SEQUENCE™ tool that the email message was deleted and never opened. The FOLLOW-UP SEQUENCE™ tool then implements the sequence of actions preprogrammed by the user.

He may open the message and then delete it without watching or listening to the multi-media presentation which may be included in the email message, for lack of interest, or because the written message was not convincing enough. This information is very useful to the user since it gives him an indication as to which messages are effective and which are not.

He may open the message but not be able to watch or listen to the presentation because of a technical problem. In response to this, the FOLLOW-UP SEQUENCE™ tool may be programmed to resend the marketing email with instructions on how to solve the technical difficulty he's having with the presentation.

He may not check his email for an extended period of time. For example, the recipient may be unable to access his email for some time because of a vacation of a business trip.

He may open the email, click on the multi-media presentation of the product or service marketed and watch or listen to the entire presentation. Or, if a web site link is included in the email instead of a presentation, he may pay a visit to the web site by clicking on the link. This may indicate the target's interest in the product or service. Accordingly, the FOLLOW-UP SEQUENCE™ tool may be programmed to send more informative email messages with more detailed presentations of the products and services sold.

He may open the email, click on the presentation of the product or service marketed and watch a portion of the presentation. In this case he may have interrupted the presentation himself or a technical problem may have occurred. The FOLLOW-UP SEQUENCE™ tool may then comprise resending the multi-media presentation with a customized written message. For example, the written message may say, “We noticed that you were not able to go through the entire presentation. In case this is due to a technical problem, we are resending the presentation”.

The FOLLOW-UP SEQUENCE™ tool may thus be preprogrammed by the user to implement a specific sequence of actions in response to how the targets respond to marketing email messages.

If and when a target replies to the first marketing email message, or any subsequent email messages, the automated FOLLOW-UP SEQUENCE™ tool may be interrupted, and the user made aware that a target has sent a reply. The user may then decide on the next course of action to be taken according to the content of the email message from the target.

An INTUITIVE AUTOMATED COMMUNICATION™ system Module part of the FOLLOW-UP SEQUENCE™ tool, allows the user to achieve a higher degree of automation for the marketing campaign and FOLLOW-UP SEQUENCE™. The INTUITIVE AUTOMATED COMMUNICATION™ system Module comprises an expert system which is capable of reading email messages received from the targets, and automatically craft a customized reply. Many of the questions posed and requests made by a target can be anticipated and usually fall into a set of typical questions and requests. Whenever the INTUITIVE AUTOMATED COMMUNICATION™ system Module is able to interpret the email message from the target, a customized reply may be automatically crafted and sent to the target by the INTUITIVE AUTOMATED COMMUNICATION™ system Module. If the target's email message cannot be interpreted, then the target's email message may be automatically forwarded to the user who may then proceed manually.

The FOLLOW-UP SEQUENCE™ tool is a flexible tool which affords the user a high degree of freedom. Indeed, the user is able design an email-based marketing campaign and FOLLOW-UP SEQUENCE™ tool with complete control of all aspects of the campaign, including, but not limited to, the content and form of the email messages, the sequence of actions to be taken according to the targets' responses or lack thereof, the number of steps involved in the sequence of actions, the time between subsequent actions, and the degree of automation to which the marketing campaign and FOLLOW-UP SEQUENCE™ tool are conducted.

Having described the invention in connection with certain embodiments thereof, variations, modifications and other applications of the present invention will certainly suggest themselves to those skilled in the art. As such, the invention is not limited to the disclosed embodiments except as required by the appended claims.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

1. A computer system for supporting sales and marketing activities of a plurality of users of the computer system, the computer system comprising:
a server connected to the Internet;
a plurality of client computers connected to the Internet, the client computers having access to the server via the Internet, the client computers being operated by the users;
software residing on the server and interacting with the client computers via the Internet; and
a database residing on the server for storing information written into the database by the software.

2. The computer system of claim 1, wherein the software interactively provides sales and marketing support services to the users.

3. The computer system of claim 2, wherein the software comprises:
a TRACKER™ tool for keeping track of sales and marketing activities of the users;
a LEADS HARVESTER™ tool for generating sales leads, the sales leads comprising email addresses of potential customers; and
a FOLLOW-UP SEQUENCE™ tool for designing and implementing email-based marketing campaigns.

4. The computer system of claim 3, wherein the tracker provides the users with Web pages for interactively entering sales and marketing activity data relating to actions performed by the users, the Web pages being displayed on the users' client computers, the data entered by the users being transmitted over the Internet to the server and stored into the database.

5. The computer system of claim 4, wherein the sales and marketing activity data comprises customer contact information, a nature of an activity performed by a user, a customer's response to the activity, a date and time the activity was performed, a nature and scheduling of the next activity to be performed by the user.

6. The computer system of claim 3, wherein the LEADS HARVESTER™ tool automatically generates sales leads by:
sending at least one email message to at least one target;
informing the target about a subject, product or service offered by a company using the LEADS HARVESTER™ tool;
providing an option to the target to forward the email message to other targets;
obtaining email addresses of the other targets; and
storing the email addresses into a record of the database;

7. The computer system of claim 6, wherein each target knows at least one other target, and the record forms a sales leads cluster;

8. The computer system of claim 7, wherein the email-based marketing campaign is designed and implemented by the user with the FOLLOW-UP SEQUENCE™ tool by:
creating at least one email message for promoting a product or service offered by a company using the FOLLOW-UP SEQUENCE™ tool;
sending the at least one email message to a plurality of potential customers;
following up the at least one email message with at least one other email message or otherwise contacting selected ones of the potential customers;

9. The computer system of claim 8, wherein the at least one other email message is customized according to responses or lack thereof provided by the potential customers.

10. The computer system of claim 9, wherein the at least one other email message is customized by an Intuitive Automated Communication Module comprising and expert system, the Intuitive Automated Communication Module being capable of interpreting email messages from potential customers, and drafting appropriate responses thereto.

11. The computer system of claim 8, wherein the FOLLOW-UP SEQUENCE™ tool is interactively programmable by the user, and as a result, a sequence of actions is performed by the FOLLOW-UP SEQUENCE™ tool.

12. The computer system of claim 11, wherein a number of times an action is performed by the FOLLOW-UP SEQUENCE™ tool and the time between consecutive actions, are programmable by the user.

13. A method of tracking sales and marketing activities of a sales representative, the method comprising the steps of:
providing a Web site with Web pages for interacting with the sales representative, the Web site residing on a server and the Web pages being displayed on a client computer of the sales representative;
from the Web pages, reading sales and marketing data entered by the user;
transmitting the data to the server via the internet; and
storing the data into a database.

14. The method of claim 13 further comprising the step of providing a statistical tool for analyzing and visualizing the sales and marketing data.

15. The method of claim 14 wherein the statistical tool is used by the sales representative to determine the most effective sales and marketing activities.

16. A method of automatically generating a plurality of sales leads pertaining to a warm market, the method comprising the steps of:
sending marketing email messages to a plurality of email recipients;
presenting, to the email recipients, a product or service offered by a company;
providing an option to the email recipients, to forward the marketing email messages to other recipients; and
keeping track of email addresses of selected email recipients; wherein a plurality of sales leads are generated, the sales leads comprising a plurality of email addresses.

17. The method of claim 16, wherein the email addresses comprise email addresses of individuals likely to show an interest in the product or service presented.

18. The method of claim 16, wherein each email recipient is connected to at least one other email recipient by a relationship, whereby the plurality of email addresses form a sales lead cluster.

19. The method of claim 16, wherein the step of presenting a product or service comprises the step of providing a multi-media presentation of the product or service.

20. The method of claim 16 wherein the step of presenting a product or service comprises the step of providing a Web link to allow an email recipient to visit a Web site by clicking on the Web link, the product or service being presented on the Web site.

21. The method of claim 18, wherein a plurality of sales lead clusters are generated.

22. A method of implementing an automated email-based marketing campaign, the method comprising the steps of:
sending at least one email message to a plurality of email recipients;
determining the type of responses or lack thereof from the email recipients;
crafting and sending to email recipients email messages customized according to the responses or lack thereof from the email recipients; and
for a predetermined number of times, following-up with possible customized email messages or otherwise contacting the recipients of the email messages.

23. This method of claim 22, wherein the step of crafting customized email messages comprises the step of interpreting written email messages from the email recipients with an expert system.

24. The method of claim 22, further comprising the step of designing the at least one email message, before the step of sending the at least one email message, wherein the at least one email message is designed to promote a product or service.

25. The method of claim 24, wherein the product or service is promoted by including multi-media presentations of the product or service as attachments to email messages.

26. The method of claim 25 wherein the product or service is promoted by providing a Web link to allow email recipients to visit a Web site by clicking on the Web link, the product or service being presented on the Web site.

27. The method of claim 22 wherein the steps of the method are comprised in a sequence of actions, and wherein a user of the method selects a number of actions in the sequence and a time between actions.

28. A Web site for supporting sales and marketing activities of at least one client company, the Web sites comprising:
a TRACKER™ tool for keeping track of sales and marketing activities of the company;
a LEADS HARVESTER™ tool for generating sales leads; and
a FOLLOW-UP™ tool for designing and implementing marketing campaigns;
wherein a user of the Web site accesses the TRACKER™ tool via a TRACKER ™ Web page, the LEADS HARVESTER™ tool via a LEAD GENERATOR™ Web page, and the FOLLOW-UP™ tool via a FOLLOW-UP™ Web page.

29. The Web site of claim of claim 28, wherein the at least one client company subscribes to services offered by the Web site.

30. The Web site of claim 28, wherein the sales leads generated by the LEADS HARVESTER™ tool are warm market sales leads.

31. A PERFORMANCE TRACKER™ system for supporting sales and marketing activities of a company, the PERFORMANCE TRACKER™ system comprising:
a TRACKER™ tool for keeping track of sales and marketing activities of the company;
a LEADS HARVESTER™ tool for generating sales leads; and
a FOLLOW-UP™ tool for designing and implementing marketing campaigns.

32. A real-time statistical analysis method for analyzing activities performed by sales persons, the method comprising the steps of:
keeping track of a number of sales;
for each sale, keeping track of the performed activities that lead to the sale;
for each individual sales person, the method allowing to identify areas in which to place training efforts.

33. The method of claim 32 further including the step of using statistical methods to correlate the number of sales to the activities which lead to each sale.

34. A real-time statistical analysis method for analyzing activities performed by at least one person, the at least one person performing the activities in order to achieve accomplishments, the method comprising the steps of:
keeping track of a number of accomplishments;
for each accomplishment, keeping track of the activities performed which lead to the accomplishment;
for each one of the at least one person, the method allowing to identify areas in which to place training efforts.

35. The method of claim 34 further including the step of using statistical methods to correlate the number of accomplishments to the activities which lead to each accomplishment.
